(19) United States
(12) Patent Application Publication
(10) Pub. No.: US 2013/0240651 A1
(43) Pub. Date: Sep. 19, 2013

(54) HAMMER CRUSHER GRILL

(71) Applicants: Erich Köhl, Meerbusch (DE); August Van Der Beek, Grevenbroich (DE)

(72) Inventors: Erich Köhl, Meerbusch (DE); August Van Der Beek, Grevenbroich (DE)

(73) Assignee: METSO LINDEMANN GmbH, Duesseldorf (DE)

(21) Appl. No.: 13/885,317

(22) PCT Filed: Sep. 15, 2011
(86) PCT No.: PCT/EP2011/065992

§ 371 Date: May 23, 2013

(30) Foreign Application Priority Data
Nov. 26, 2010 (EP) 1001 5021.8

(51) Int. Cl. B02C 13/284

(52) U.S. Cl. CPC B02C 13/284
USPC 241/79.2

(57) ABSTRACT

The invention relates to a hammer crusher grate with multiple crossing thick plates, wherein the thick plates are interconnected with each other in a force-fit way via corresponding profiles while forming the grate structure.

The invention relates to a hammer crusher grate. A hammer crusher, also called a hammer mill, is a comminution machine (crusher, shredder) which is used since long—for example—for industrial treatment of raw materials but as well for comminuting scrap (residual materials). Central element of a hammer crusher is a rotor with a horizontally arranged shaft (axis) and circulating comminuting tools (hammers) which act onto the material to be crushed. Their comminuting effect is based on the impact treatment (hitting) of the base material caused by the hammers hinged to said rotor.

Hammer crushers can be equipped with one or more rotors which in most cases are arranged centrically in the working area of the shredder. The following disclosure, for simplicity reasons, relates to one shaft hammer mills but may be transferred analogously to hammer mills with multiple rotors.

The base material, crushed by the hammers, is then after treated (further comminuted) by a so called exit grate (grid) and guided out of the machine. There are several designs for such grates. One option is a so called bar grate, made of several grate bars, arranged at a distance to each other. The bars may have a trapezoidal cross section such that the grate, following the shape (design) of the cylindrical rotor, runs more or less parallel to and at a distance to the rotor surface along a certain wrap angle.

While the through openings for the material to be crushed are defined by the distance of the grate bars in a bar grate, several discrete through openings are formed within grid like grates, providing a much smaller cross sectional area, thus allowing a classification (sizing) corresponding to the cross sectional shapes of said through openings.

Such grid like grates can be made, for example of manganese chilled casting, chromium chilled casting or other alloyed cast steel. During the comminuting process the material undergoes a strong impact treatment and a high frictional wear. There exists an increased danger for the cast parts to break. It is possible to reduce the affinity to break by a reduction of the rigidity (strength) of the selected alloy. But this reduces the working time (operating time) as wear increases by friction.

With cast parts made of manganese hard steel an increase in volume during impact treatment is observed. This is undesired.

Further grates are known which are made as welded constructions (welded assembly). But those have the disadvantage that especially along the welded areas the hardness is much reduced. The danger of crack formation by notch effects exists along the weld seams. Thus the weld seams undergo an increased wear progress. Because of the weld seams (welded joints) the grate may be deformed and must then be readjusted in a complex way. Further its manufacture is expensive.

The invention has the object to optimize a generic hammer mill grate with respect to hardness, ductility, wear behavior and working time. In this respect the invention is in particular related to a grid like grate (steel grating).

The invention is mainly based on two, technically and functionally related features, namely:
use of a thick plate as a product for manufacturing the grate
design of the bars made of thick plates with profiles to provide a force-fit connection between the bars to achieve the grate structure

EN 10029 defines thick plates as steel plates with a thickness t≧3.00 mm. They are milled (rolled) steel plates replacing the previously used cast elements.

The profiles may be provided by pressing/punching or burning (burning out). Both methods are known, simple and cheap to accomplish.

The used plates can be alloyed or non-alloyed. The may have a thickness up to 400 mm. As explained in more detail hereinafter in particular thick plates are used for the new hammer crusher grates having a width of 50 to 150 mm and a height between 100 and 400 mm. The thick plates/grate bars have excellent mechanical and thermo mechanical features. An exemplary material and its mechanical features are described in connection with the following embodiment.

According to the invention the milled/rolled plates are interconnected/assembled via said profiles mentioned, giving the said desired grate structure and in such a way that a self-supporting construction is formed.

In its most general embodiment the invention therefore relates to a hammer crusher grate with multiple crossing bars (thick plates), wherein the thick plates are interconnected with each other in a force-fit way (actuated by friction) via corresponding profiles and forming the grate structure.

According to another embodiment the thick plates are arranged crosswise and interconnected via corresponding protrusions and recesses (male and female parts).

The thick plates (metal strips, metal bars) can be designed comb-shaped as disclosed in the embodiment disclosed hereinafter. In one embodiment at least 70% of the thick plates are designed comb-like.

The crosswise arranged metal plates can extend to each other under an angle of 90 degrees such that through openings are formed between the metal plates which provide a rectangular cross sectional profile. Depending on the use situation the through openings along the grate can have different cross-sectional areas and/or different cross sectional shapes. Beside rectangular, square and slit like openings the openings may as well have a rhombus like or a trapezoidal like cross section.

Insofar as in relation to an inventive grate its main sides (surfaces) are mentioned hereinafter one main side relates to that side of the grate, facing the rotor of the hammer mill and the other main side is the side opposite to the first side.

Several thick plates can be joined in such a way that at least one main side of the grate structure provides the shape of a partial surface of a cylinder. Such a geometry may also be realized with plates, having a rectangular cross section. In this case the (imaginary) cylinder surface is provided by the metal plates by planar surface areas, but wherein the orientation of the metal plates, seen along the complete grate, then is such that the corresponding main side mostly runs parallel to the rotor surface.

It is obvious that the metal plates can also be designed with a corresponding bending/curvature in the corresponding surface area. In this context the two main sides may extend parallel/concentric to each other.

In another embodiment the geometry of the grate is such that the distance between grate and rotor becomes smaller in the rotating direction and/or that the dimension (the cross sectional area) of individual through openings between the metal plates becomes smaller in the rotating direction.

A decisive parameter for the stability of the overall grate is the axial moment of inertia, i.e. the factor for the resistance of the cross section against bending. Accordingly one embodiment of the invention is characterized by at least 70% of the metal plates having a height, perpendicular to at least one main side of the grate, which is at least 1.5 times larger than its width. “Perpendicular to the main side of the grate” does not necessarily mean 90 degrees but is to be understood in a technical sense such that the orientation of the metal plates is essentially radial to the corresponding main side (main surface).

According to one embodiment the relation height/width is 24 2.

The form-fit connection of the crosswise arranged metal plates (thick plates, metal bars, metal strips) can be realized by a precise dimensioning of corresponding male and female parts (protrusions and recesses). The basic principle therefore is an interconnection/form-fit of crosswise arranged metal elements (metal plates) without any additional fixtures. In any case the connection is realized in such a way that the friction excludes a loosening of the metal plates for example during transport and/or assembly.

In the mounted position this is typically of no importance any more, if the assembly (the mounting) of the individual metal bars is such that rests (bearings) exist for all construction parts which are placed outside in the transport direction of the material to be crushed.

The assembly of the grate in a hammer crusher can for example be realized such that metal plates, running parallel to the rotor shaft, are fixed with their ends at corresponding walls, while metal plates, extending in a perpendicular direction, are mounted onto the lengthwise (axially) running metal plates (are latched into these), as again disclosed in more detail in the embodiment described hereinafter.

If wanted individual welding spots may be provided in the contact area of crossing metal plates, especially as a transportation safety means. They do not have any mechanical function during operation of the hammer crusher and especially they do not have mechanical tasks relating to the fixation of the grate and/or its parts.

Further features of the invention derive from the features of the sub-claims and the other application parts.

The invention will be described hereinafter in more detail with respect to one embodiment.

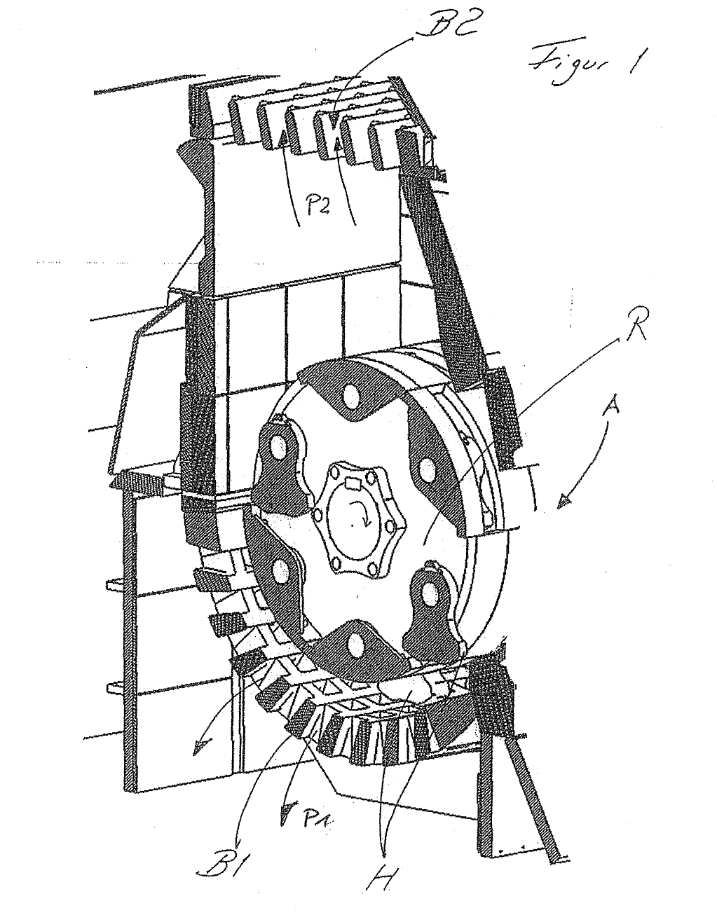

FIG. 1 represents one embodiment of a hammer crusher (hammer mill). As a hammer crusher is known as such only the important elements are described hereinafter:

At A the charging material is introduced (fed in) and then crushed because of the high rotational speed of rotor R and the high impact energy of said hammers H. Because of the interaction of said hammers H and the shape of the grate openings in the grates B1 and B2 the crushed (comminuted) material is discharged (arrows P1, P2).

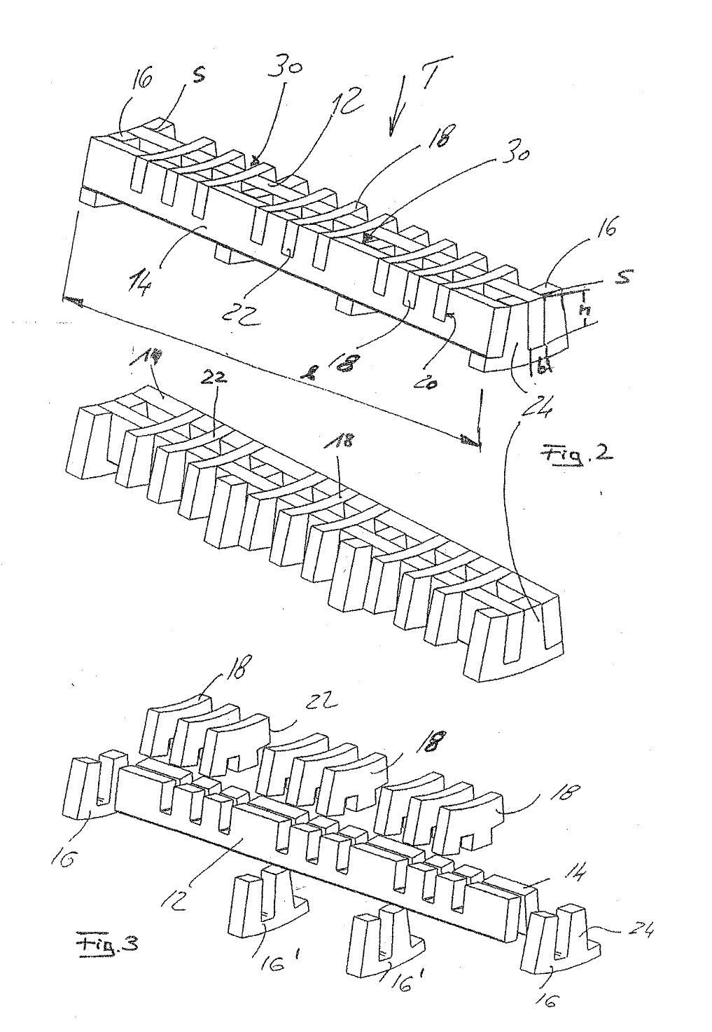

FIG. 2 shows a part of an inventive grate, which is made of two metal plates 12, 14, arranged at a distance to each other and which are connected with each other and interconnected in a force-fit and form-fit manner by 13 further thick plates, wherein the metal plates at the end are characterized by numeral 16 and the intermediate metal plates by 18, 16′.

The metal strips 12, 14 have a length L, being slightly larger as the axial length of the corresponding rotor R. Each metal strip 12, 14 has a height H, being approximately 3 times larger than the respective width B, from which a favorable momentum of inertia in the direction of arrow T derives, wherein the direction given by arrow T approximately corresponds to the direction along which the material to be crushed falls onto the grate 10.

Each of said metal strips 12, 14 has nine recesses 20, so that each metal strip 12, 14 receives a comb shape as may best be seen from FIG. 3, Corresponding protrusions 22 of said metal strips 18 fit into said recesses 20, wherein said metal strips 18 have a comb shape as shown in FIG. 3.

The dimensioning of the metal plates 18 is adapted to correspond with the dimensioning of the recesses 20 in such a way that a form-fit and force-fit connection is realized and thus a self- supporting structure of the grate.

At their ends the metal plates 12, 14 are connected with each other by metal strips 16, which are constructed similarly to the metal plates 18, but which are mounted from below against and in between the metal plates 12, 14 as best shown in FIG. 2.

According to that each of the pin like protrusions 24 of said metal plates 16 has a trapezoidal cross section in a plan view such that the metal plates 12, 14 set onto and into it do not run parallel to each other but in an inclined manner. This is true as well with respect to the metal plates 16′, which are mounted from below between the metal plates 16 and provide an additional form-fit and force-fit connection with said metal plates 12, 14.

Analogously metal plates 18 are shaped, meaning that each pin like protrusion is designed with a trapezoidal cross section, wherein said part is arranged between the metal plates 12, 14 when the grate is fully mounted.

In FIG. 2, 3 only a part of a grate is shown. It is obvious that the length and the width of the grate may be enlarged and/or reduced in an analogous manner. Further the distances between adjacent metal plates 12, 14, 16, 18, 16′can be varied and thus the openings 30 which are arranged between the metal strips (thick plates) 12, 14, 16, 18, 16′.

At the same time the metal strips 16, 16′ serve as a bearing (rest) for the fixation of the grate in a hammer crusher.

All metal bars (strips, plates) are made of milled (rolled) heavy plates (thick plates). Their height is about 250 mm, their width b in the range of 70 mm. The length of the metal plates 12, 14 is in the range of 2700 mm in the shown embodiment.

All metal plates 12, 14, 16, 18, 16′ of this embodiment consist of a high performance (high strength) water quenched wear resistant steel. The water quenched steel has a hardness of 400 to 600 HB and is offered under the material numbers 1.8721 and 1.8715 [DIN EN 10027]. These qualities are also suitable for other embodiments of the invention.

If it is desired to mount the total grate in a hammer crusher in a pre-mounted condition is may be suitable to additionally stabilize the construction, which per se is self-supporting, by individual welding spots between corresponding construction parts. Such exemplary welding spots are shown in FIG. 2 by reference symbol S.

FIG. 2, 3 also demonstrate that the metal plates 16, 18, 16′are curved on the surface facing the rotor such that in total (FIG. 2) a main side of the grate is provided which approximately corresponds to a section of a cylinder surface. The curvature is selected depending on the respective rotor, further depending on whether the arrangement of the grate is parallel to the rotor surface or slightly eccentric.

1. A hammer crusher grate with multiple crossing thick plates (12, 14, 16, 18, 16′), wherein the thick plates are interconnected with each other in a force-fit way via corresponding profiles (20, 22,24) while forming the grate structure.

2. The hammer crusher grate according to claim 1, wherein the crosswise arranged thick plates (12, 14, 16, 18, 16′) and interconnected via corresponding protrusions and recesses (20,22, 24).

3. The hammer crusher grate according to claim 1, wherein at least 70% of the thick plates (12, 14, 16, 18, 16′) are designed comb-like.

4. The hammer crusher grate according to claim 1, wherein the crossing thick plates (12, 14, 16, 18, 16′) extend under an angle of 90° to each other.

5. The hammer crusher grate according to claim 1, wherein the crossing thick plates (12, 14, 16, 18, 16′) are interconnected in a form-fit manner.

6. The hammer crusher grate according to claim 1, wherein several thick plates (12, 14, 16, 18, 16′) are interconnected in such a way that at least one main side of the grate structure has the shape of a partial surface of a cylinder.

7. The hammer crusher grate according to claim 1, wherein several thick plates (12, 14, 16, 18, 16′) predominantly have a rectangular cross section, perpendicular to their longitudinal extension.

8. The hammer crusher grate according to claim 1, wherein the thick plates (12, 14, 16, 18, 16′) are shaped and arranged in such a way that grate openings (30) with rectangular cross section are arranged between them.

9. The hammer crusher grate according to claim 1, wherein the thick plates (12, 14, 16, 18, 16′) are shaped and arranged in such a way that grate openings (30) arranged between them provide a substantially same size.

10. The hammer crusher grate according to claim 1 with two parallel main sides.

11. The hammer crusher grate according to claim 1, wherein at least 70% of the thick plates (12, 14, 16, 18, 16′) have a height (H), perpendicular to at least one main side of the grate, being at least 1.5 times larger than its width (B).

12. The hammer crusher grate according to claim 1, wherein at least 70% of the thick plates (12, 14, 16, 18, 16′) have a height (H), perpendicular to at least one main side of the grate, being at least 2 times larger than its width (B).

13. The hammer crusher grate according to claim 1, providing several welding spots in the contact area of crossing thick plates (12, 14, 16, 18, 16′) as a transportation security means.

14. The hammer crusher grate according to claim 1, wherein the thick plates are designed and arranged in such a way that the grate is self-supporting.
